(19) United States
(12) Patent Application Publication
(10) Pub. No.: US 2003/0064789 A1
(43) Pub. Date: Apr. 3, 2003

(54) Gaming apparatus and gaming apparatus control method

(76) Inventor: Takahiro Suzuki, Tokyo (JP)

Correspondence Address: COLLARD & ROE, P.C., 1077 Northern Boulevard, Roslyn, NY, 11576-1696, US

(21) Appl. No.: 10/226,621

(22) Filed: Aug. 23, 2002

(30) Foreign Application Priority Data
Aug. 24, 2001 (JP) 2001-255005

(51) Int. Cl. A63F 13/00

(52) U.S. Cl. 463/20

(57) ABSTRACT

There is provided a gaming apparatus, a gaming apparatus control method, a program, and a computer-readable recording medium, which enable attraction of players' interest by employment of a new method of affording players bonuses and which enable the players to readily ascertain that they are in the course of a bonus game. The gaming apparatus has a display including a plurality of symbol display areas, and a controller. When the controller has started a bonus game, the gaming apparatus displays selectable specific symbols in X display areas, thereby prompting the player to select specific symbols of predetermined number A. The specific symbols include at least one increment symbol to be used for increasing the number of remaining chances the player has to select a specific symbol. When having appropriately selected the increment symbols, the player can select all the specific symbols, thereby acquiring a large amount of bonus.

### BACKGROUND OF THE INVENTION

1. Field of the Invention

The invention relates to a gaming apparatus, a gaming apparatus control method, a program, and a computer-readable recording medium, wherein symbols are displayed in a plurality of display areas and an award is to be given to a player on the basis of the arrangement of symbols.

2. Background Art

A slot machine is a typical gaming apparatus which determines symbols to be displayed in a plurality of display areas through use of random numbers and determines occurrence of a win on the basis of the arrangement of symbols appearing in the display areas.

In a conventional slot game, in many cases when a predetermined number of symbols are sequentially aligned along a line from the leftmost symbol, a player is awarded a bonus according to the arrangement of the symbols. Players are not satisfied with a gaming apparatus which provides a bonus according to such an existing method, and demand the advent of a new type of gaming apparatus.

Recently, game contents have tended to become more complicated, and it has become more difficult for a player to ascertain that he/she is in the course of a bonus game.

The invention has been conceived to solve the problem and aims at providing a gaming apparatus, a gaming apparatus control method, a program, and a computer-readable recording medium, which enable attraction of players' interests by employment of a new method of affording players bonuses and enable the players to readily ascertain that they are in the course of a bonus game.

### SUMMARY OF THE INVENTION

(1) According to the present invention, a gaming apparatus comprises:

a display having a plurality of symbol display areas in which a plurality of types of symbols are variably displayed; and

a controller which executes a predetermined program and controls details to be displayed on the display, wherein

the controller performs the following operations in accordance with the program;

an operation for causing the display to variably display the symbols;

an operation for determining, from among the plurality of types of symbols, the symbols to be displayed in the respective display areas;

an operation for affording a player a reward on the basis of an arrangement of the symbols appearing in the respective display areas;

an operation for starting a bonus game on the display under predetermined conditions;

an operation for displaying specific symbols selectable for the player in a total of X display areas on the display during the bonus game;

an operation for causing the player to select specific symbols of predetermined number A from among the displayed X specific symbols (A<X); and

an operation for determining a bonus to be awarded to the player on the basis of the selected specific symbols;

wherein the displayed specific symbols include at least one increment symbol which, when selected by the player, increases, by a specific number, the number of remaining chances the player has to select the specific symbols; and,

wherein selection of all X specific symbols is possible when the increment symbols are selected.

According to a gaming apparatus of the present invention, in the course of a bonus game a player is prompted to select specific symbols of predetermined number A from among X specific numbers appearing on a display, thereby determining a bonus to be award to the player. The specific symbols include at least one increment symbol. When selected by the player, the increment symbol increases the number of remaining chances the player has to select the specific symbols. If the player has failed to select any increment symbol, the player can select only a portion of the X symbols. In contrast, if the player has appropriately selected all the increment symbols, the player can select all the specific symbols, thereby acquiring a larger amount of bonus. Therefore, the player anticipates selection of all the specific symbols, whereby the entertainment nature of the gaming apparatus is enhanced. Further, the symbols appearing in the X display areas turn into specific symbols in conjunction with start of a bonus game, thereby facilitating acknowledgement of occurrence of a bonus game.

Preferably, a plurality of increment symbols are available, and the total number by which chances can be increased is (X−A), where the total number may be obtained by subtracting A from X. As a result, in order to select all X specific symbols, the player is required to appropriately select a plurality of increment symbols, thus posing difficulty in selecting all X specific symbols. Hence, the player's challenging aspiration is eventually augmented, whereby an entertainment characteristic is enhanced.

(2) According to the present invention, a slot machine may be provided which includes a display having a plurality of symbol display areas in which a plurality of types of symbols are variably displayed, and which determines a reward to be afforded to a player on the basis of an arrangement of symbols appearing in the respective display areas, the machine comprising:

execution means for executing a bonus game on the display under a predetermined condition;

display means for displaying specific symbols selectable for the player in X display areas on the display during the bonus game;

selection means for selecting specific symbols of specific number A from among the displayed X specific symbols (A<X); and

determination means for determining a bonus to be awarded to the player on the basis of the selected specific symbols;

wherein the displayed specific symbols include at least one increment symbol which, when selected by the player, increases, by a specific number, the number of remaining chances of the player may select the specific symbols; and

wherein selection of all X specific symbols is possible when the increment symbols are selected.

According to the slot machine of the invention, during the course of a bonus game a player is prompted to select specific symbols of predetermined number A from among X specific symbols appearing on a display, thereby determining a bonus to be awarded to the player. The specific symbols include at least one increment symbol. When selected by the player, the increment symbol increases the number of remaining chances the player has to select the specific symbols. If the player has failed to select an increment symbol, the player cannot select all X symbols. In contrast, if the player has appropriately selected all the increment symbols, the player can select all the specific symbols, thereby acquiring a larger amount of bonus. Therefore, the player anticipates selection of all the specific symbols, whereby the entertainment nature of the gaming apparatus is enhanced. Further, the symbols appearing in the X display areas turn into specific symbols in conjunction with start of a bonus game, thereby facilitating ascertainment of occurrence of a bonus game.

(3) According to the present invention, a controlling method may be provided for controlling a gaming apparatus including a display having a plurality of symbol display areas in which a plurality of types of symbols are variably displayed, and a controller for controlling details of a display on the display, the method comprising:

a step of variably displaying the symbols on the display;

a step of determining the symbols to be displayed in the respective display areas from among the plurality of types of symbols;

a step of affording a player a reward on the basis of an arrangement of the symbols appearing on the respective display areas;

a step of starting a bonus game on the display under predetermined conditions;

a step of displaying specific symbols selectable for the player in X display areas on the display during the bonus game;

a step of prompting the player to select specific symbols of predetermined number A from among the displayed X specific symbols (A<X);

a step of determining a bonus to be awarded to the player on the basis of the selected specific symbols;

a step of causing the displayed specific symbols to include at least one increment symbol which, when selected by the player, increases, by a specific number, the number of remaining chances the player has to select the specific symbols; and

a step of rendering all X specific symbols selectable when the increment symbols are selected.

According to the gaming apparatus control method of the invention, during a bonus game a player is prompted to select specific symbols of predetermined number A from among X specific numbers appearing on a display, thereby determining a bonus to be awarded to the player. The specific symbols include at least one increment symbol. When selected by the player, the increment symbol increases the number of remaining chances the player has to select the specific symbols. If the player has failed to select any increment symbol, the player can select only a portion of the X symbols. In contrast, if the player has appropriately selected all the increment symbols, the player can select all the specific symbols, thereby acquiring a larger amount of bonus. Therefore, the player anticipates selection of all the specific symbols, whereby the entertainment nature of the gaming apparatus is enhanced. Further, the symbols appearing in the X display areas turn into specific symbols in conjunction with start of a bonus game, thereby facilitating ascertainment of occurrence of a bonus game.

Preferably, a plurality of increment symbols are available, and a total number by which chances of selection can be increased is (X−A), where the total number may be obtained by subtracting A from X. As a result, in order to select all X specific symbols, the player is required to appropriately select a plurality of increment symbols, thus posing difficulty in selecting all X specific symbols. Hence, the player's challenging aspiration is eventually augmented, whereby an entertainment characteristic is enhanced.

(4) According to the present invention, a program may be provided for causing a computer to execute:

a step of variably displaying symbols on a display having a plurality of symbol display areas in which a plurality of types of symbols are variably displayed;

a step of determining the symbols to be displayed in the respective display areas from among the plurality of types of symbols;

a step of affording a player a reward on the basis of an arrangement of the symbols appearing on the respective display areas;

a step of starting a bonus game on the display under predetermined conditions;

a step of displaying specific symbols selectable for the player in X display areas on the display during the bonus game;

a step of prompting the player to select specific symbols of predetermined number A from among the displayed X specific symbols (A<X);

a step of determining a bonus to be awarded to the player on the basis of the selected specific symbols;

a step of causing the displayed specific symbols to include at least one increment symbol which, when selected by the player, increases, by a specific number, the number of remaining chances the player has to select the specific symbols; and

a step of rendering all X specific symbols selectable when the increment symbols are selected.

(5) According to the invention, a computer-readable recording medium may be provided on which the program set forth above is recorded.

By means of the program set forth and by means of causing a computer to execute such a program recorded on a recording medium, there can be yielded advantages such as those described in connection with the gaming apparatus and the method of controlling the gaming apparatus. Specifically, during a bonus game a player is prompted to select specific symbols of predetermined number A from among X specific numbers appearing on a display, thereby determining a bonus to be awarded to the player. The specific symbols include at least one increment symbol. When selected by the player, the increment symbol increases the number of remaining chances the player has to select the specific symbols. If the player has failed to select any increment symbol, the player can select only a portion of the X symbols. In contrast, if the player has appropriately selected all the increment symbols, the player can select all the specific symbols, thereby acquiring a larger amount of bonus. Therefore, the player anticipates selection of all the specific symbols, whereby the entertainment nature of the gaming apparatus is enhanced. Further, the symbols appearing in the X display areas turn into specific symbols in conjunction with start of a bonus game, thereby facilitating ascertainment of occurrence of a bonus game.

### BRIEF DESCRIPTION OF THE DRAWINGS

FIG. 1 is an external perspective view showing a gaming apparatus (slot machine) according to the present invention.

FIG. 2 is a block diagram showing a controller for controlling processing of the slot machine shown in FIG. 1.

FIG. 3 is a view showing a display screen of a main display 20.

FIG. 4 is a symbol table showing symbols to be displayed on respective reels.

FIG. 5 is a flowchart showing a method of controlling the slot machine until a bonus game is started.

FIG. 6 is a flowchart showing the method of controlling the slot machine in which a bonus game is proceeding.

FIG. 7 is a view showing bonus symbols when the symbols are displayed along a straight line within a display area of a main display.

FIG. 8 is a view showing nine specific symbols which appear on the display areas of the main display during a bonus game.

FIG. 9 is a view showing a payout being displayed during the bonus game by means of the player having selected a display area B1.

FIG. 10 is a view showing additional symbols which have appeared in a display area A1 during the bonus game by virtue of the player having selected display areas A1, B1, and B3.

FIG. 11 is a block diagram showing individual modules of a program of the invention.

FIG. 12 is a view showing a computer-readable recording medium (CD-ROM) having the program shown in FIG. 11 recorded thereon.

### DETAILED DESCRIPTION OF THE PREFERRED EMBODIMENT

A preferred embodiment according to the present invention will be described in detail herein below by reference to the accompanying drawings. Like elements are assigned like reference numerals, and their repeated explanations may be omitted.

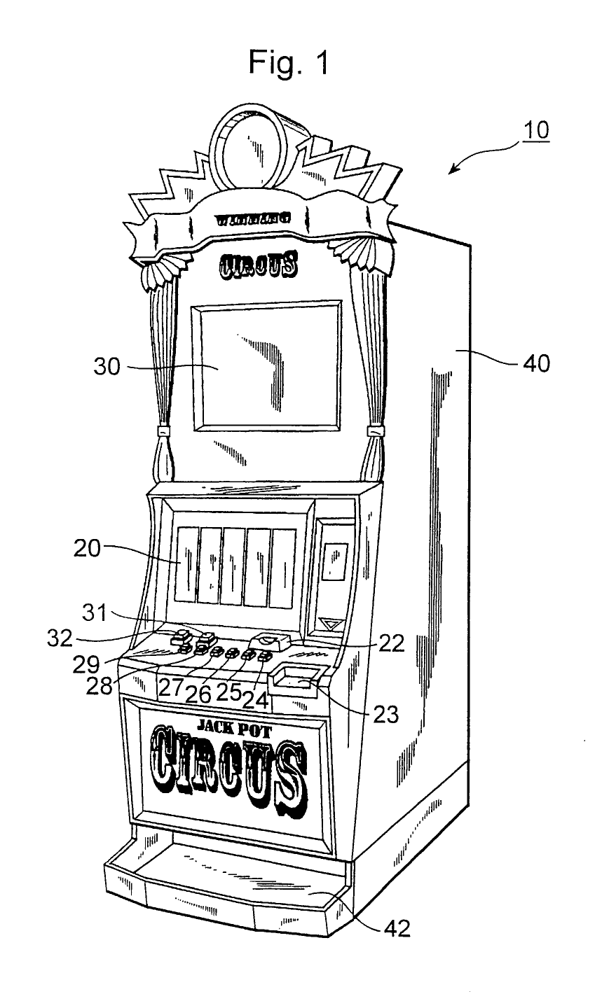

FIG. 1 is an external perspective view showing a slot machine (gaming machine) 10 of the embodiment. The slot machine 10 has a display 20 which is provided in a lower portion of a housing 40 and digitally displays a slot game. A second display 30 is provided in an upper portion of the housing 40 for digitally displaying a sub-game or a like game. The main display 20 and the second display 30 are both liquid-crystal display devices. The main display 20 serves as a touch screen.

A coin insertion part 22 where mediums such as a token as a coin (hereinafter generically called “coins”) and a paper money (bill) insertion part 23 to be used for insertion of a bill are provided in a lower area in front of the main display 20. A player can play a slot game with either coin or a bill. As a matter of course, the slot machine may be configured so as to enable the player to play a game with only a coin or with only a bill. Further, a coin receiving part 42 where the player receives paid out coins is provided in the lowest portion of the housing 40.

Six press buttons are arranged in an area in front of the coin insertion part 22. Those buttons are also provided on a known slot machine. Specifically, among those buttons the right most button is a start button 24 to be used for instructing initiation of spinning of symbols, and the remaining buttons are, from right to left, a BET button 25 to be used for instructing a 1 BET action; a MAX BET button 26 to be used for betting the maximum number of coins (e.g., 30 coins) from remaining credits; a REPEAT BET button 27 to be used for betting the same number of coins as those bet in a previous session; a collect button 28 to be used for determining coins acquired in games; and a payout button 29 to be used for instructing payout of coins. Further, two selection buttons 31, 32 are provided on the left side of the coin insertion part 22 in the drawing, and the buttons are to be used for a game which proceeds on the second display 30.

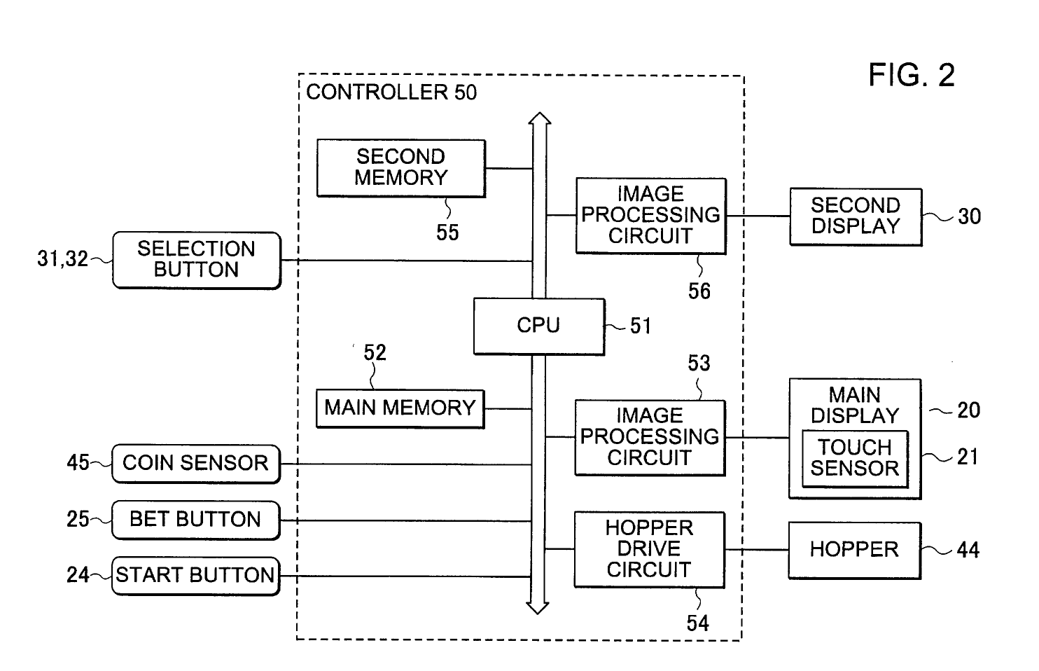

FIG. 2 is a block diagram showing a controller 50 for controlling processing of the slot machine 10 of the embodiment and various actuators electrically connected to the controller 50.

The controller 50 includes a CPU 51 having control over various control operations; main memory 52 serving as storage means for storing a program and data required for executing a slot game; an image processing circuit 53 which has video RAM and controls details (or contents) to be displayed on the main display 20; a hopper drive circuit 54 for controlling a hopper 44 for paying off accumulated coins to the player; second memory 55 serving as storage means which stores a program and data required for executing a sub game; and an image processing circuit 56 which has VIDEO RAM and controls contents to be displayed on the second display 30. Here, an I/O port or the like is disposed between the CPU 51 and the actuators as required.

The main memory 52 has a ROM area and a RAM area. The ROM area stores at least a module to be used for executing the slot game, a program pertaining to a bonus game, and data pertaining to symbol images. Variable data, such as the number of coins bet by the player and the number of credits, are written into the RAM area of the main memory 52. Similarly, the second memory 55 also has a ROM area and a RAM area. A program and data pertaining to a sub game or the like game are written in the ROM area. A touch sensor 21 is built into the main display 20, and the player can enter various information items by means of touching the screen of the display.

The CPU 51 is connected to a coin sensor 45, a start button 24, a BET button 25, and the selection buttons 31, 32 by way of a bus. Although omitted from the drawings, various other buttons and a bill sensor are also connected to the controller 50. Moreover, the hopper 44 and the coin sensor are housed in the housing 40 shown in FIG. 1.

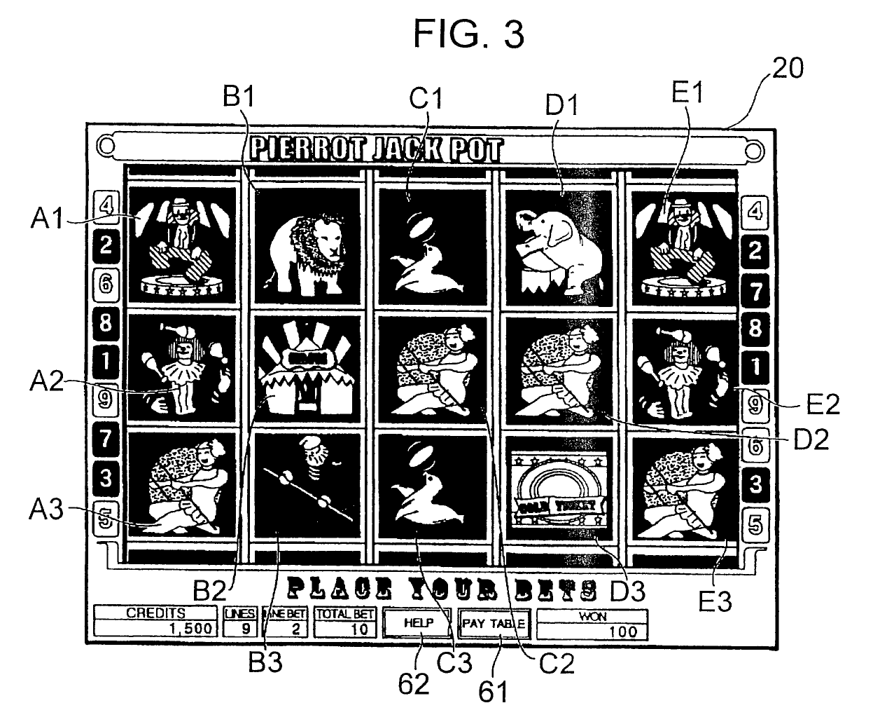

FIG. 3 is a view showing a display screen of the main display 20. In the embodiment, the main display 20 has a total of 15 display areas into which a plurality of symbols are to be displayed, the areas being arrayed into a matrix of three rows and five columns. Reels, which have a plurality of types of painted symbols on their peripheral surfaces, are spun. When the reels have come to a standstill, images are processed such that selected symbols are displayed in the display areas A1 through A3; B1 through B3; C1 through C3; D1 through D3; and E1 through E3.

Displayed below the individual display areas are the number of remaining credits, the number of valid lines (LINES), the number of coins bet on respective lines (LINE BET), the total number of coins bet by the player at this time (TOTAL BET), and the number of coins awarded to the player at this time as a reward (WON). Further, a PAY TABLE key 61 for instructing indication of a pay table showing the amount of payment to the player and a HELP key 62 for seeking a help for uncertainties about the way of playing a game are also displayed on the main display 20. When the player has touched any of the keys 61, 62, the touch sensor 21 detects the touch, whereupon explanations about a pay table and an operating method are displayed on the screen.

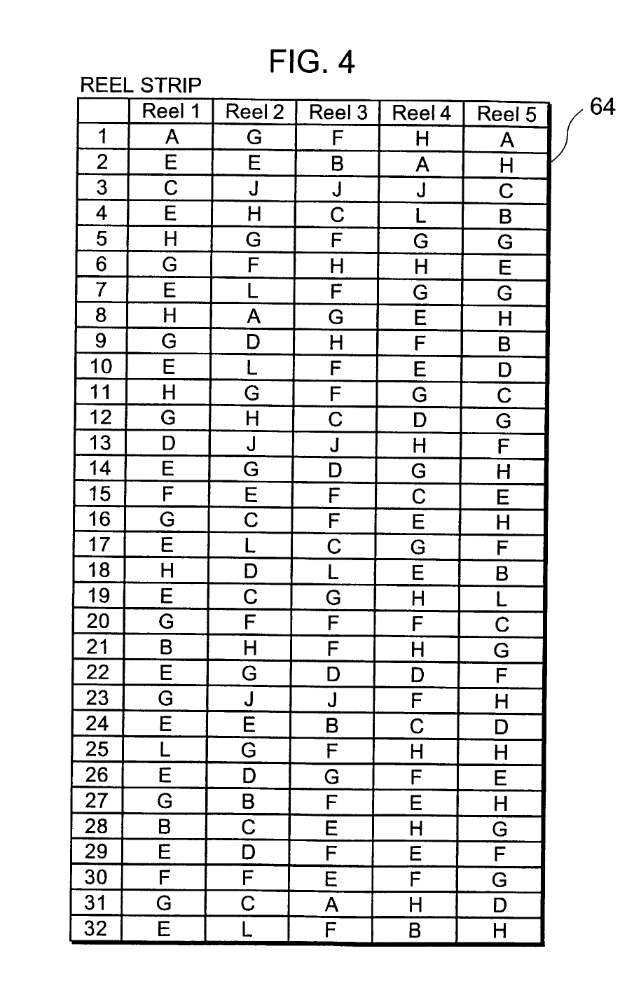

FIG. 4 is a symbol table 64 showing symbols to be displayed on the respective reels. Information about the symbol table 64 is stored in the main memory 52. Letters of alphabet shown in the table represent the respective types of symbols. Images are formed in the display area of the main display 20 such that symbols are drawn on the respective reels in such sequences shown in the symbol table 64. For instance, the fifth letter “H” printed on the first reel represents a bonus symbol.

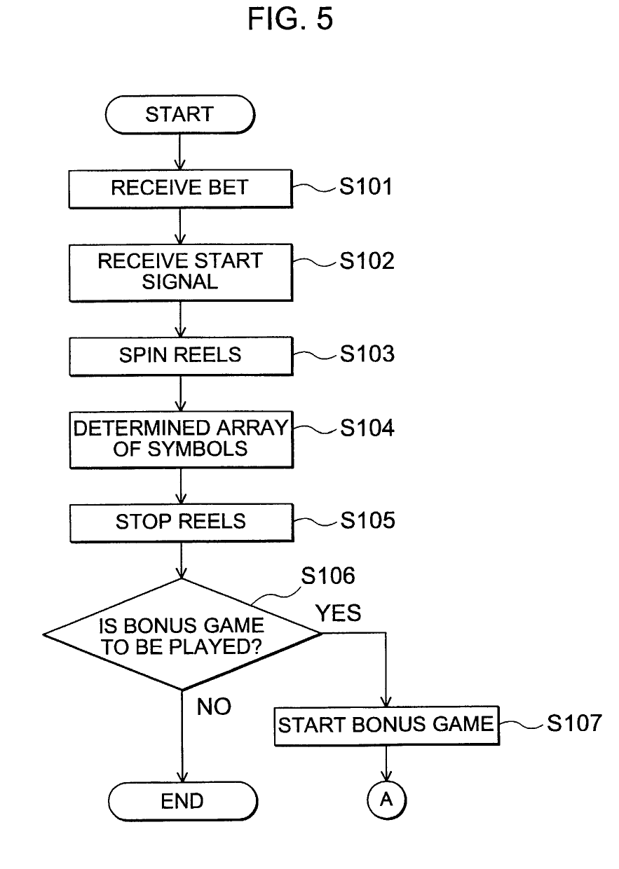

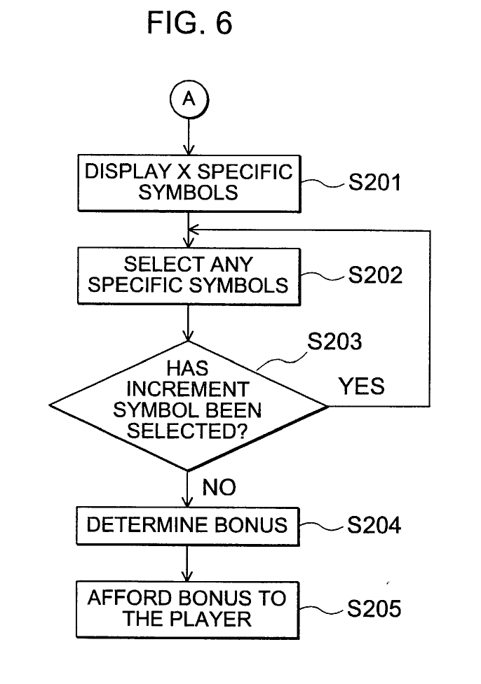

By reference to flowcharts shown in FIGS. 5 and 6, a slot machine control method of the embodiment will now be described.

First, control operations of the slot machine 1 to be performed until a bonus game is started will be described.

When the slot machine 10 is activated, the CPU 51 accesses the main memory 52, thereby transferring to the image processing circuit 53 information about a basic screen of a slot game, such as frames defining a display area or the PAY TABLE key 61. The image processing circuit 53 temporarily stores the information into the video RAM and then displays the information on the main display 20. As a result, the slot machine 10 enters a state in which a player can play the slot game. The following procedures are performed when the CPU 51 executes a module of the program stored in the main memory 52 pertaining to the slot game.

In step 101 (hereinafter a term “step” is abbreviated as “S”), the CPU 51 of the controller 50 awaits a betting operation (BET). The BET operation can be performed when credits still remain. The player instructs the number of coins bet by means of pressing any one of the BET button 25, the MAX BET button 26, and the REPEAT BET button 27.

When the player presses the start button 24 after having performed the BET operation (S102), the reels start spinning on the main display 20 (S103). More specifically, upon receiving a start signal from the start button 24, the CPU 51 controls the image processing circuit 53, thereby performing an image processing operation as if real reels were spinning. When the player has pressed either the MAX BET button 26 or the REPEAT BET button 27, reels start spinning without involvement of pressing of the start button 24. After the reels have started spinning, the CPU 51 generates random numbers in accordance with a program stored in the main memory 52. In accordance with the random numbers, the CPU 51 determines stop positions of the reels; that is, symbols to be displayed on the respective display areas (S104). Drawing operation based on a table of random numbers may be performed at any timing. For instance, the drawing operation may be performed when the start button 24 is pressed, or the drawing operation may be performed again at each time the BET button is pressed.

Next, the CPU 51 controls the image processing circuit 53, thereby stopping the reels on the main display 20 (S105). At this time, settings may be made such that at least one symbol appears in each display area. Alternatively, settings may be made such that, depending on random numbers, no symbol appears or only a portion of symbol appears in at least one display area. In the embodiment, at least one symbol is assumed to appear in each of the display areas.

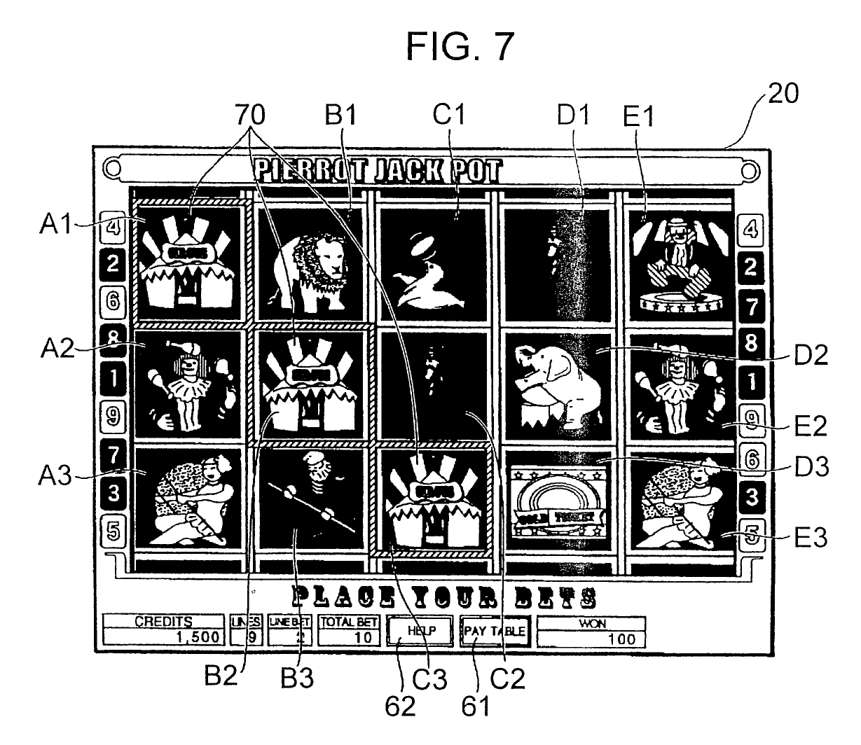

The CPU 51 determines whether or not a bonus game is to be performed (S106). A bonus game is determined to be performed in one of the following circumstances; for example, when a specific arrangement of bonus symbols (The symbol depicting a tent is employed as a bonus symbol in the embodiment.) indicated by “H” shown in FIG. 4 in the slot game, and when a determination is made as to whether a bonus game is to be performed on the basis of random numbers generated by the program stored in the main memory 52, and the like. In the embodiment, when tent symbols, which are bonus symbols indicated by “H” shown in FIG. 4, are displayed and aligned with a straight line, as shown in FIG. 7, a bonus game is performed. When a bonus game has been determined not to be performed, the slot game is terminated, and, for example, a message “GAME OVER” appears on the main display 20.

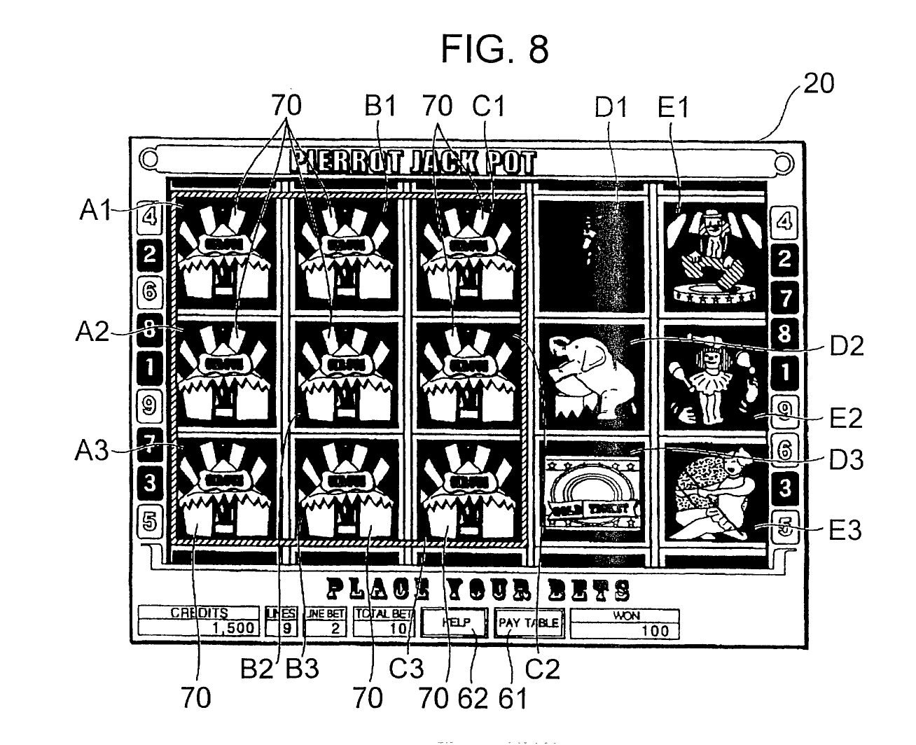

When in step S106 the bonus game is determined to be performed, the CPU 51, which serves as execution means, executes a module pertaining to a bonus game of the program stored in the main memory 52, thereby commencing a bonus game (S107). FIG. 8 is a view showing a state in which X specific symbols 70 (X equals 9 in the embodiment) are displayed in the display area on the main display 20. Here, the specific symbols 70 correspond to images of tents, which are bonus symbols.

Here, specific symbols 70 are displayed in a 3-by-3 array at the left end display areas of the main display 20. However, the display layout of specific symbols is not limited to this array. For example, X specific symbols 70 may be displayed in display areas chosen randomly.

FIG. 6 shows a flowchart representing a method of controlling the slot machine 10 during the bonus game. The following processing is performed as a result of the CPU 51 executing a module pertaining to the bonus game of the program stored in the main memory 52.

When a bonus game is started, the CPU 51 controls the image processing circuit 53 serving as display means, thereby causing the circuit to display X specific symbols 70 in the display areas on the main display 20 (S201). In the embodiment, the number X of specific symbols 70 is set to nine. However, the value of X is variable. For instance, displaying specific symbols of a number on the basis of an array of symbols determined in step S104 is also conceivable.

The CPU 51, serving as selection means, arbitrarily selects a predetermined number A of specific symbols from among the nine specific symbols (S202). The player selects the specific symbols 70 one by one by means of touching the display 20. At this time, a selection instruction for prompting the player to perform selection operation may be displayed in the display area of the display 20. The number A of specific symbols to be selected, which is given to the player at the beginning, is set so as to become smaller than the number X of the specific symbols 70 (A<X) In the embodiment, A is set to a value of 3 (A=3).

The CPU 51, serving as determination means, determines a bonus on the basis of the specific symbols 70 selected by the player, in accordance with the program stored in the main memory 52.

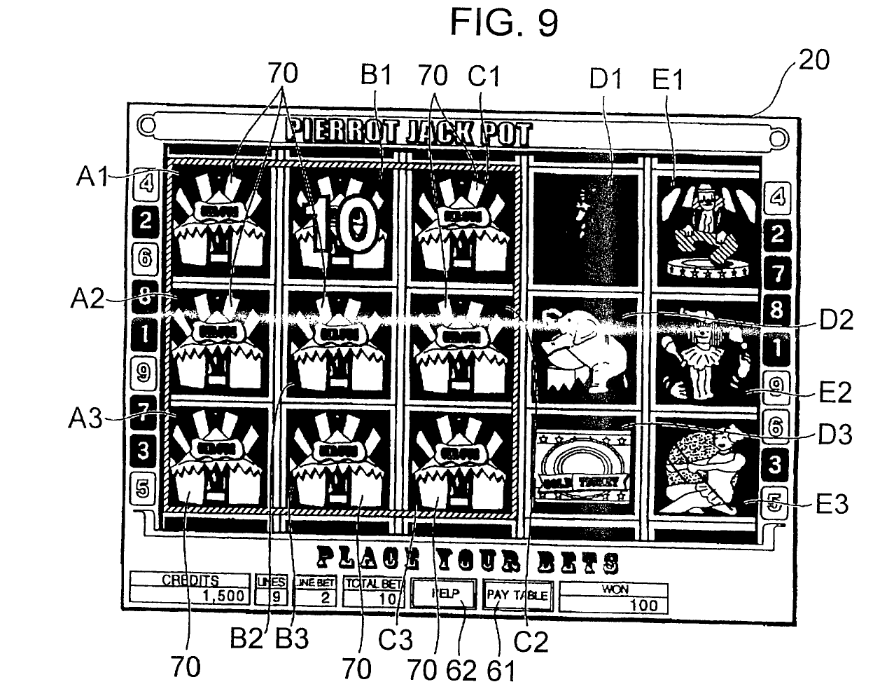

FIG. 9 is a view showing that a reward is displayed as a result of the player having selected the display area B1. In pursuant to the thus-displayed reward, coins or the like are paid to the player. Here, although “10” is displayed as a sample of a reward, as a matter of course another value may be employed. In the embodiment, a bonus is embodied as payment of a reward, such as coins. However, offering a sub game to the player on the second display 30 or the like may also be employed as a bonus.

Among the number X Of specific symbols 70, an increment symbol 71 is included. If the player selects the increment symbol 71, the number of remaining chances that the player can select the specific symbol 70 is additionally increased.

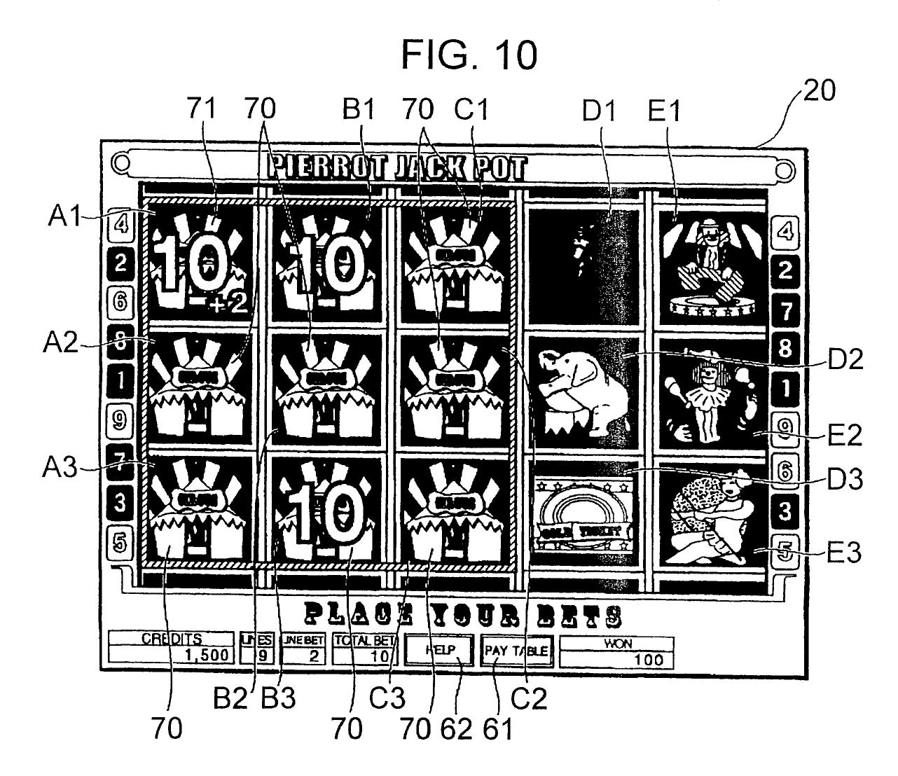

FIG. 10 shows the increment symbol 71 appearing in the display area A1 as a result of the player having selected the display areas A1, B1, and B3.

In the drawing, the increment symbol 71 indicates a reward to be afforded to the player and the number of chances to be added to the remaining chances that the player can select the specific symbol. Here, the number of additional chances is represented as “+2,” and hence the number of chances that the player can select the specific symbol 70 is increased by two. Specifically, the player is at first given A (=3) chances of selecting the specific symbol. By selecting the increment symbol 71, the number of remaining chances that the player can select the specific symbol 70 is increased by two, and hence the total of five chances are available.

Here, at least one increment symbol 71 is present, and the total number of additional numbers provided by the increment symbols 71 is set to (X−A), where the total number may be given by subtracting A from X. If the player appropriately selects all the increment symbols 71, the player can select all the specific symbols 70 (the tent symbols as the bonus symbol in the embodiment), whereby the player can get more reward.

For example, in the embodiment, since X equals 9 (X=9) and A equals 3 (A=3), nine specific symbols 70 include three increment symbols 71, where each increment symbol increases by two the number of remaining chances that the player may select the specific symbol 70. In this case, one increment symbol 71 is selected until three specific symbols 70 are selected, thereby increasing the total number of selections to five. Next, another increment symbol 71 is selected until two more specific symbols 70 are selected (in total five times), thereby increasing the total number of selections to seven. Moreover, the remaining increment symbol 71 is selected until two more specific symbols 71 are selected (in total seven times). As a result, the player can select all the specific symbols 70. In other words, when a plurality of increment symbols 71 are included and when the total number of increments is assumed to be (X−A), the player can select all X specific symbols 70 only when all the increment symbols 71 can be selected within the number of the chances.

If the player has failed to perform appropriate selection, the bonus game ends at a point of time when the number of chances that the player can perform selection has become 0. The rewards the player has acquired thus far are paid to the player.

If the bonus is embodied in the manner mentioned above and if the player can have appropriately selected the increment symbols 71, the player can select all the specific symbols 70 appearing on the display area of the display 20, thereby enabling acquisition of a larger amount of bonus. For this reason, the player anticipates selection of all the specific symbols 70, where by the entertainment nature of the game is enhanced. Further, symbols appearing in the X display areas turn into the specific symbols 70 in conjunction with start of a bonus game, thereby facilitating the player's recognition of occurrence of the bonus game.

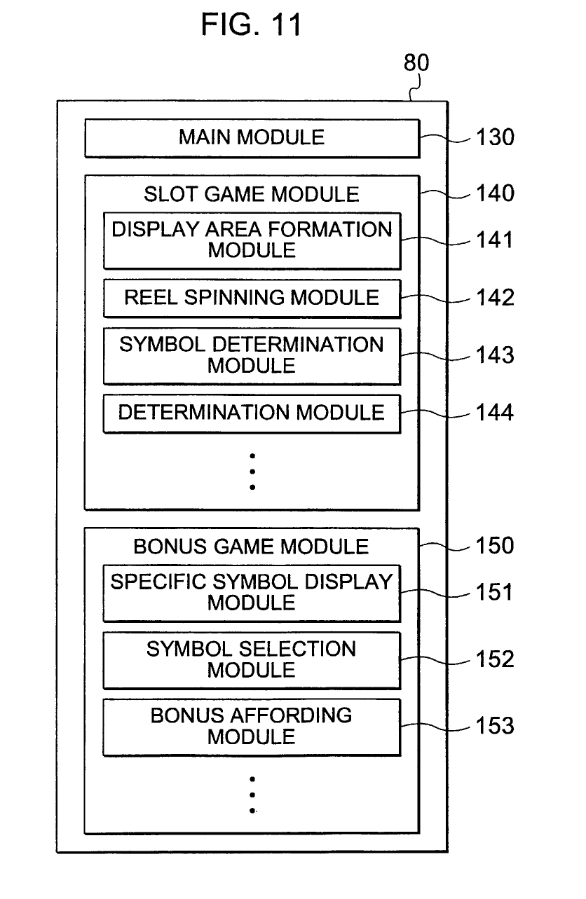

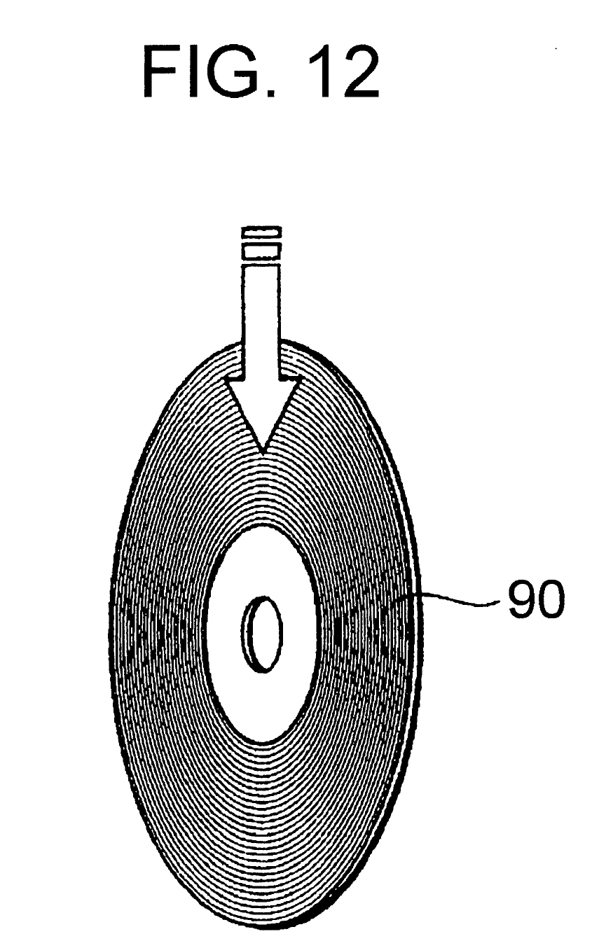

By reference to FIGS. 11 and 12, a preferred embodiment of a program of the invention and a computer-readable recording medium having the program recorded thereon will now be described.

FIG. 11 is a view showing individual modules of a program 80 of the embodiment. FIG. 12 is a view showing a CD-ROM (recording medium) 90 having the program 80 written thereon.

The program 80 comprises a main module 130 for controlling processing in a centralized manner; a slot game module 140 pertaining to processing of the slot game; and a bonus game module 150 pertaining to processing of a bonus game.

The slot game module 140 includes at least a display area formation module 141, a reel spinning module 142, a symbol determination module 143, and a determination module 144.

The display area formation module 141 forms, on the display, a display area onto which symbols are to be displayed. The reel spinning module 142 rotationally displays reels on the display. The symbol determination module 143 determines symbols to be displayed in the respective display areas on the basis of a table of random numbers. As a result of a computer executing these modules, processing pertaining to S101 through S107 shown in FIG. 5 can be executed in the slot machine 10.

The bonus game module 150 includes at least a specific symbol display module 151, a symbol selection module 152, and a bonus award module 153.

The specific symbol display module 151 displays, in the display areas on the display 20, specific symbols which the player can select. The specific symbols 70 include an increment symbol 71. In a case where X specific symbols 70 are displayed and where the number of chances to select one among the specific symbols 70 is set to A at the beginning, the total added number of chances for selection is set to (X−A). The symbol selection module 152 causes the player to select arbitrarily a symbol from the selectable specific symbols. The bonus affording module 153 awards the player a bonus in accordance with the selected symbols. As a result of a computer executing the individual modules, processing pertaining to steps S201 to S205 shown in FIG. 6 can be implemented in the slot machine 10.

As mentioned above, when the program 80 which is acquired by way of a communication network, such as the Internet, or the program 80 recorded on the CD-ROM 90 is installed in any of various computers, such as a personal computer or a portable information terminal (e.g., a personal digital assistance: PDA), a game analogous to that provided on the slot machine 1 can be realized.

Here, image data required for implementing a game, such as symbols or characters, a pay table, or another table to be used for embodying a bonus may have been incorporated into the program 80 in advance. Alternatively, data may be installed into a computer from a source other than a program. Further, the program 80 may be equipped with any modules required for effecting processing to be performed by the slot machine 10, other than the modules shown in FIG. 11.

The recording medium may be embodied by any type of medium, so long as the medium enables a computer to read written data. For instance, a magnetic disk such as a floppy disk (FD), an optical disk such as a DVD, a semiconductor storage device, or the like may be included.

The present invention has been described specifically by reference to the embodiment. However, the present invention is not limited to the embodiment. For instance, symbols appearing vertically in respective display areas may spin independently instead of indication of spinning reels. Symbols may be displayed variably in display areas on a display by causing mechanical reels to spin, where the symbols are displayed on the circumferential surfaces.

Drawing or choosing symbols to be displayed in the display areas may be performed not by utilization of random numbers obtained by a program but on the basis of random numbers generated by a random number generator.

In addition, a controller for a main display and another controller for a second display may be provided separately. Alternatively, a CPU may be provided for a game to be displayed on respective displays. The main display and the second display may be any type of display, such as a CRT, a plasma display, an organic EL display, or the like.

The gaming apparatus of the invention is not limited to the slot machine. For instance, the slot game may be executed on, e.g., a liquid-crystal screen of a pachinko machine. Alternatively, the game may be executed on a gaming apparatus (e.g., a Pachislo machine) equipped with a stop button to be used by the player for stopping the reels.

What is claimed is:

1. A gaming apparatus comprising:
a display having a plurality of symbol display areas in which a plurality of types of symbols are variably displayed; and
a controller which executes a predetermined program and controls details to be displayed on the display,
wherein the controller performs in accordance with the program:
an operation for causing the display to variably display the symbols;
an operation for determining symbols to be displayed in the display areas from among the plurality of types of symbols;
an operation for determining a reward to be afforded to a player based on an arrangement of the symbols appearing on the display areas;
an operation for starting a bonus game on the display under a predetermined condition;
an operation for displaying specific symbols selectable for the player in X display areas respectively on the display during the bonus game;
an operation for causing the player to select a predetermined number A of specific symbols from among the displayed X specific symbols, the number A being smaller than the number X; and
an operation for determining a bonus to be awarded to the player based on the selected specific symbols;
wherein the displayed specific symbols include at least one increment symbol which, when selected by the player, adds a predetermined number to the number of remaining chances that the player can select the specific symbol; and,
wherein selection of all X specific symbols is possible when the increment symbols are selected.

2. The gaming apparatus according to claim 1,
wherein the displayed specific symbols include a plurality of increment symbols, and
wherein a total added number of the chances is (X−A).

3. A slot machine which includes a display having a plurality of symbol display areas in which a plurality of types of symbols are variably displayed, and which determines a reward to be afforded to a player based on an arrangement of symbols appearing in the respective display areas, the machine comprising:
execution means for executing a bonus game on the display under a predetermined condition;
display means for displaying specific symbols selectable for the player in X display areas on the display during the bonus game;
selection means for causing the player to select a predetermined number A of specific symbols from among the displayed X specific symbols, the number A being smaller than the number X; and
determination means for determining a bonus to be awarded to the player based on the selected specific symbols;
wherein the displayed specific symbols include at least one increment symbol which, when selected by the player, adds a predetermined number to the number of remaining chances that the player can select the specific symbol; and,
wherein selection of all X specific symbols is possible when the increment symbols are selected.

4. A method of controlling a gaming apparatus including a display having a plurality of symbol display areas in which a plurality of types of symbols are variably displayed, and a controller for controlling details to be displayed on the display, the method comprising:
variably displaying the symbols on the display;
determining the symbols to be displayed in the respective display areas from among the plurality of types of symbols;
determining a reward to be afforded to a player based on an arrangement of the symbols appearing on the respective display areas;
starting a bonus game on the display under a predetermined condition;
displaying specific symbols selectable for the player in X display areas on the display during the bonus game;
causing the player to select a predetermined number A of specific symbols from among the displayed X specific symbols, the number A being smaller than the number X;
determining a bonus to be awarded to the player on the basis of the selected specific symbols;
causing the displayed specific symbols to include at least one increment symbol which, when selected by the player, adds a predetermined number to the number of remaining chances that the player can select the specific symbol; and
rendering all X specific symbols selectable when the increment symbols are selected.

5. The method of controlling a gaming apparatus according to claim 4,
wherein the displayed specific symbols include a plurality of increment symbols, and
wherein a total added number of the chances is (X−A).

6. A computer executable program comprising:
variably displaying symbols on a display having a plurality of symbol display areas in which a plurality of types of symbols are variably displayed;
determining the symbols to be displayed in the respective display areas from among the plurality of types of symbols;
determining a reward to be afforded to a player based on an arrangement of the symbols appearing on the respective display areas;
starting a bonus game on the display under a predetermined condition;
displaying specific symbols selectable for the player in X display areas on the display during the bonus game;
causing the player to select a predetermined number A of specific symbols from among the displayed X specific symbols, the number A being smaller than the number X;
determining a bonus to be awarded to the player based on the selected specific symbols;
causing the displayed specific symbols to include at least one increment symbol which, when selected by the player, adds a predetermined number to the number of remaining chances that the player can select the specific symbol; and
making all X specific symbols selectable when the increment symbols are selected.

7. A computer-readable recording medium storing the program as claimed in claim 6.
